(19) United States
(12) Patent Application Publication
(10) Pub. No.: US 2022/0255764 A1
(43) Pub. Date: Aug. 11, 2022

(54) FEDERATED LEARNING PLATFORM AND MACHINE LEARNING FRAMEWORK

(71) Applicant: SoterOne, Inc., Pleasanton, CA (US)

(72) Inventors: Guoxin Li, Redmond, WA (US); Si Yin, Sunnyvale, CA (US)

(21) Appl. No.: 17/666,481

(22) Filed: Feb. 7, 2022

Related U.S. Application Data
(60) Provisional application No. 63/146,592, filed on Feb. 6, 2021.
(60) Provisional application No. 63/146,589, filed on Feb. 6, 2021.
(60) Provisional application No. 63/146,586, filed on Feb. 6, 2021.
(60) Provisional application No. 63/149,324, filed on Feb. 14, 2021.
(60) Provisional application No. 63/254,078, filed on Oct. 9, 2021.

(51) Int. Cl. H04L 9/00; G06N 20/00; G06F 21/62; H04L 9/08; G06F 9/48

(52) U.S. Cl. CPC H04L 9/50; G06N 20/00; H04L 2209/46; H04L 9/085; G06F 9/4806; G06F 21/6227

(57) ABSTRACT

Systems and methods of a novel self-serve, customer driven data platform that can automatically unify and structure the data that comes from different sources, in order to provide well defined data for any federated learning task. This platform solves a critical problem for federated learning which usually requires multiple different data sources jointly learning one model. In the real-world scenario, the assumption that most existing federated learning frameworks have, that different data owners follow the same rule or structure to save the data, usually does not hold. Our data platform is the one of the novel and heuristic ways to solve this practical problem and makes larger scale and automated industrial level federated learning achievable.

### CROSS-REFERENCE TO RELATED APPLICATIONS

This application claims benefit of U.S. Provisional Patent Application No. 63/146,592, Attorney Docket soter.00001.us.p.1, filed on Feb. 6, 2021, and entitled “A New Blockchain Based Privacy Preserving Federated Learning Framework.” U.S. Provisional Patent Application No. 63/146,592 is incorporated by reference herein, in its entirety.

This application claims benefit of U.S. Provisional Patent Application No. 63/146,589, Attorney Docket soter.00001.us.p.2, filed on Feb. 6, 2021, and entitled “A New Multi-Party Computation with Secret Sharing (MPC-SS) Scheme for Vertical Federated Logistic Regression Machine Learning.” U.S. Provisional Patent Application No. 63/146,589 is incorporated by reference herein, in its entirety.

This application claims benefit of U.S. Provisional Patent Application No. 63/146,586, Attorney Docket soter.00001.us.p.3, filed on Feb. 6, 2021, and entitled “A New Blockchain Consensus Scheme to Support Secure Multi-Party Computation and Machine Learning.” U.S. Provisional Patent Application No. 63/146,586 is incorporated by reference herein, in its entirety.

This application claims benefit of U.S. Provisional Patent Application No. 63/149,324, Attorney Docket soter.00001.us.p.4, filed on Feb. 14, 2021, and entitled “A Novel Self-Serve, Customer Driven Data Standardization Scheme for Federated Learning Platform.” U.S. Provisional Patent Application No. 63/149,324 is incorporated by reference herein, in its entirety.

This application claims benefit of U.S. Provisional Patent Application No. 63/254,078, Attorney Docket soter.00001.us.p.5, filed on Oct. 9, 2021, and entitled “Blockchain-based Encrypted Reliable Cloud Storage with public trace.” U.S. Provisional Patent Application No. 63/254,078 is incorporated by reference herein, in its entirety.

### BACKGROUND

Over time, data becomes more and more important to all different kinds of industries and applications. Back in 2017, The Economist published a story titled, “The world's most valuable resource is no longer oil, but data.” Beside the data itself, how to effectively use the data is another question we should ask ourselves. With the development of the Internet, most companies hold a significant amount of data for helping their business. Even though they have enough data, it is hard to expand the diversity of their data, because with the privacy concern, most companies can't share their data with each other, which makes them become isolated data islands. In fact, in the real world, data owners can save the data in any kind of database, format and content, it is impossible to directly combine the data and feed into a federated learning framework. But currently most existing federated learning frameworks are built on the assumption that all the data owners follow the same rule or structure to save the data, without any component or solution to deal with the data discrepancy among the data owners. To solve this problem, we offer a privacy preservation platform which makes it possible to safely and securely make private data available for sharing. In order to achieve this, one fundamental step is to have a standard data format for all of the different data owners, with unified representation of the same information and at the same time help us avoid or prevent discrepancy between each data owner.

Logistic regression is a well-known supervised machine learning method, and it is used to predict the probability of two or more classes such as win/lose, like/dislike. Logistic regression is easy to be trained, explained and has a solid statistical support. It is widely used in various fields, including machine learning, most medical, engineering and social sciences.

Vertical federated learning involves two or more data owners jointly learning a model by sharing their data in a privacy preserving environment. In this setting, each data owner maintains their own private data of different features about common entities (users, items), so that each data owner contributes to train a global model from locally computation on local data. In the vertical setting, the data is split by features (vertically), only one data owner has the target variable, and each data owner does not know the common entities across all the data owners.

Standard machine learning approaches require centralizing the training data on one machine or in a datacenter. Google first built one of the most secure and robust cloud infrastructures for training machine learning models on user mobile devices without collecting data into one center server. This approach is called Federated Learning. Federated Learning enables mobile phones to collaboratively learn a shared prediction model while keeping all the training data on device, decoupling the ability to do machine learning from the need to store the data in the cloud.

### SUMMARY

In general, in one aspect, embodiments relate to systems and methods for blockchain-based federated learning and machine learning, data standardization for machine learning, multi-party computation with secret sharing, and execution of horizontal and vertical federated logistic regression.

In general, in one aspect, embodiments relate to a system for federated learning, including a computer processor, a backend service configured to: (i) receive a query from a federated learning query customer, (ii) receive a request for details of the query from a set of data owners, (iii) provide details of the query to the set of data owners, (iv) receive responses to the query from the set of data owners, each response comprising encrypted data, and (v) trigger execution of a federated learning task using the encrypted data; and a blockchain driver and monitor executing on the computer processor and configured to enable the computer processor to: (i) record an indication of the query on a distributed cryptographic blockchain, wherein the set of data owners are notified of the query by directly or indirectly observing the distributed cryptographic blockchain, and (ii) record the federated learning task on the distributed cryptographic blockchain, wherein one or more computation nodes are notified of the federated learning task by directly or indirectly observing the distributed cryptographic blockchain.

In general, in one aspect, embodiments relate to a method for federated learning, including: (i) receiving a query from a federated learning query customer, (ii) receiving a request for details of the query from a set of data owners, (iii) providing details of the query to the set of data owners, (iv) receiving responses to the query from the set of data owners, each response comprising encrypted data, (v) triggering execution of a federated learning task using the encrypted data, (vi) recording an indication of the query on a distributed cryptographic blockchain, wherein the set of data owners are notified of the query by directly or indirectly observing the distributed cryptographic blockchain, and (vii) recording the federated learning task on the distributed cryptographic blockchain, wherein one or more computation nodes are notified of the federated learning task by directly or indirectly observing the distributed cryptographic blockchain.

In general, in one aspect, embodiments relate to a non-transitory computer-readable storage medium comprising a set of instructions for federated learning, the set of instructions configured to execute on at least one computer processor to enable the at least one computer processor to: (i) receive a query from a federated learning query customer, (ii) receive a request for details of the query from a set of data owners, (iii) provide details of the query to the set of data owners, (iv) receive responses to the query from the set of data owners, each response comprising encrypted data, (v) trigger execution of a federated learning task using the encrypted data, (vi) record an indication of the query on a distributed cryptographic blockchain, wherein the set of data owners are notified of the query by directly or indirectly observing the distributed cryptographic blockchain, and (vii) record the federated learning task on the distributed cryptographic blockchain, wherein one or more computation nodes are notified of the federated learning task by directly or indirectly observing the distributed cryptographic blockchain.

Other embodiments will be apparent from the following description and the appended claims.

### BRIEF DESCRIPTION OF THE DRAWINGS

Embodiments are illustrated by way of example, and not by way of limitation, in the figures of the accompanying drawings and in which like reference numerals refer to similar elements.

FIGS. 1A and 1B illustrate block diagrams of a federated learning platform and machine learning framework, in accordance with one or more embodiments.

FIGS. 2A and 2B illustrate a machine learning training framework based on blockchain.

FIG. 3 illustrates an overview of a data transformation API for generating standardized data in the data platform.

FIG. 4 illustrates a flowchart of a Multi-Party Computation with Secret Sharing (MPC-SS) scheme.

FIGS. 5-6 illustrate logistic regression algorithms, in accordance with one or more embodiments.

FIGS. 7A-7D depict block diagrams, flow diagrams, and processes of a reputation system.

FIGS. 8 and 9 show a computing system and network architecture in accordance with one or more embodiments.

### DETAILED DESCRIPTION

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the invention. While described in conjunction with these embodiments, it will be understood that they are not intended to limit the disclosure to these embodiments. On the contrary, the disclosure is intended to cover alternatives, modifications, and equivalents, which may be included within the spirit and scope of the disclosure as defined by the appended claims. It will be apparent to one of ordinary skill in the art that the invention can be practiced without these specific details. In other instances, well-known features have not been described in detail to avoid unnecessarily complicating the description.

The disclosure relates to a novel self-serve, customer driven data platform that can automatically unify and structure the data that comes from different sources, in order to provide well defined data for any federated learning task. This platform solves a critical problem for federated learning which usually requires multiple different data sources jointly learning one model. In the real-world scenario, the assumption that most existing federated learning frameworks have, that different data owners follow the same rule or structure to save the data, usually does not hold. Our data platform is the one of the novel and heuristic ways to solve this practical problem and makes larger scale and automated industrial level federated learning achievable.

The disclosure relates generally to a new Multi-Party Computation (MPC) with Secret Sharing (MPC-SS) scheme for Vertical Federated Logistic Regression Machine Learning, to preserve privacy among different data sources. The current vertical federated logistic regression uses homomorphic encryption (HE) to handle the privacy issues when the multiple data owners share the data to train one model. What we observed is that homomorphic encryption cannot fully solve the privacy problem, because it requires a trusted server to aggregate all the data owners' gradients to update a global model. In order to achieve that, the trusted server must see all the data owners' gradients in plaintext and send the plaintext global gradient back to each data owner. If a trusted server is attacked or dishonest, the data owners have a risk of leaking their data. After carefully reviewing the gradient of logistic regression, embodiments of the invention were designed to utilize MPC-SS to learn the model without a trusted server while maintaining data privacy.

The disclosure relates generally to a new privacy preserving federated learning framework by utilizing and adopting the modern blockchain technology. Comparing to existing federated learning framework, our framework is driven by the blockchain which brings openness and transparency to the users. Embodiments of the invention support a broad range of machine learning and deep learning algorithms in both horizontal and vertical federated learning. Furthermore, all the algorithms' computations are achieved in the user's local environment and all the data exchange actions are performed on the Multi-Party Computation (MPC) with Differential Privacy (DP) which gives a security environment for users to safely exchange the data without leaking the confidential information.

The disclosure relates generally to a new blockchain consensus scheme to utilize the computing power of the blockchain miners to support secure multi-party computation and machine learning. The high-level idea is to have a cluster of P2P nodes and incentivize them to register as the MPC computing nodes in parallel to serving as the validator and leader in blockchain mining.

Blockchain-Based Privacy Preserving FLF

This disclosure describes systems and methods of a Privacy Preserving Federated Learning Framework (FLF) based on the blockchain. The presented disclosure first describes what federated learning is and what the challenges are to apply into the industrial applications. Then it describes how we design a blockchain based Privacy Preserving Federated Learning framework to solve those difficulties by utilizing blockchain technology and cryptography. It gives a detailed description of the main components of the framework, which are blockchain driver and monitor, encryption algorithms, data preprocessor, horizontal and vertical federated learning respectively. Finally, we describe in detail how those components collaborate to implement the real-world application of horizontal and vertical federated learning.

One or more embodiments of the invention expand the framework of federated learning, optionally beyond mobile devices to different data owners and to collaboratively training better machine learning models. Advantages of various embodiments of the invention include, but are not limited to: 1) openness and transparency to the customers and data owners during the whole training and prediction process, 2) preserving privacy information of the data owner's data, and avoiding leaks of any personal information during the training and prediction process, 3) supporting variations of well-known machine learning and deep learning algorithms in vertical and horizontal settings, and 4) handling different data types and formats across different data owners.

In one or more embodiments of the invention, a distributed management system tackles the problems 1) to 4), listed above. In one or more embodiments of the invention, the Federated Learning Framework (FLF) comprises the following five components:

1) Blockchain driver and monitor

2) Privacy preservation engine

3) Data preprocessor

4) Vertical federated learning module

5) Horizontal federated learning module

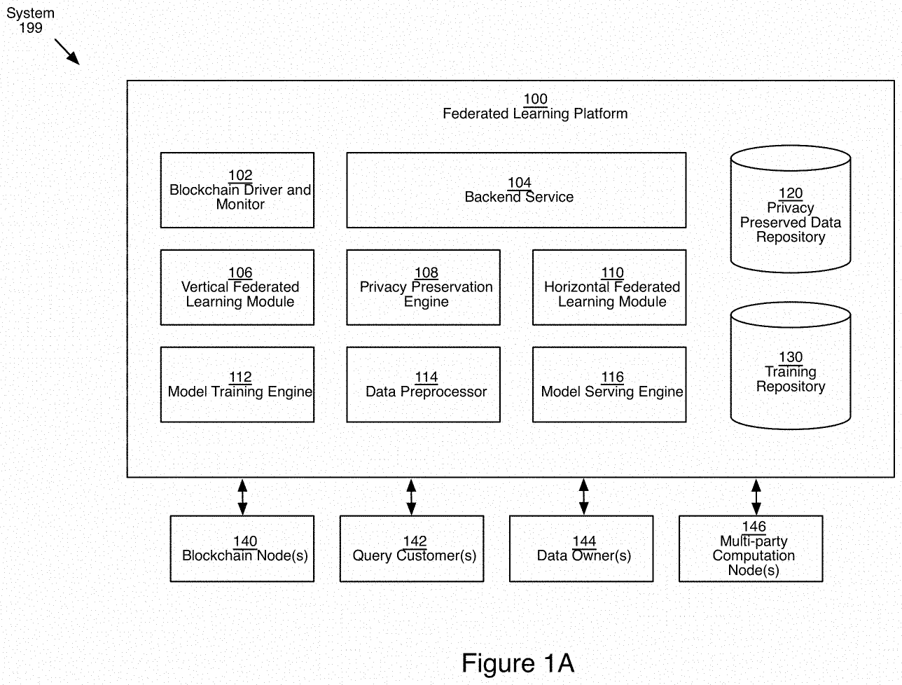

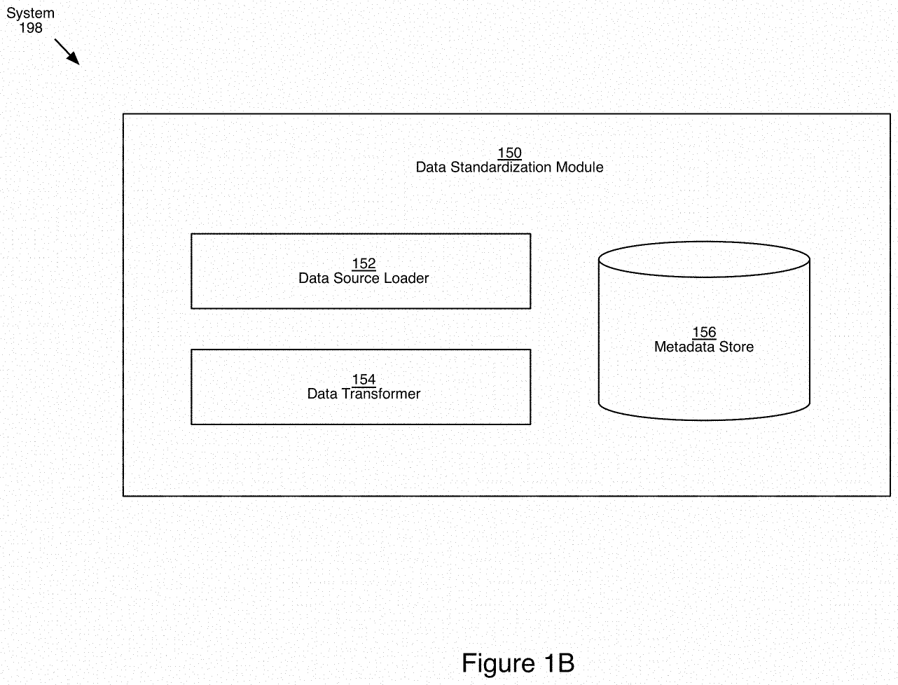

FIG. 1A shows a federated learning system 199 including a federated learning platform 100, in accordance with one or more embodiments. As shown in FIG. 1A, the federated learning platform 100 includes a blockchain driver and monitor 102, a backend service 104, a vertical federated learning module 106, a privacy preservation engine 108, a horizontal federated learning module 110, a model training engine 112, a data preprocessor 114, a model serving engine 116, a privacy preserved data repository 120, and a training repository 130. The system 199 may also include integration with one or more blockchain nodes (e.g., 140), one or more query customers (e.g., 142), one or more data owners (e.g., 144), and/or one or more multi-party computation nodes (e.g., 109). In one or more embodiments, the system 199 is configured to perform federated learning in various different configurations and optional embodiments.

Blockchain driver and monitor 102: Blockchain is a growing list of records that are linked using cryptography. Each block contains a cryptographic hash of the previous block, a timestamp, and transaction data. By design, a blockchain is resistant to modification of its data. This is because once recorded, the data in any given block cannot be altered retroactively without alteration of all subsequent blocks. Because of the character of the blockchain, it becomes a best suited technology to support our framework. The blockchain driver and monitor 102 includes functionality to push all the machine learning related events and intermediate results on the chain, which makes our process to be transparent and trustable to all the users, and/or to display the whole task process on the blockchain with hash value and timestamps.

When the learning task involves multiple data owners and MPC nodes, the blockchain driver and monitor 102 uses the blockchain's block height to check the liveness of the data owners and MPC nodes and ensure the synchronization of them. As we know, the block height is equivalent to the latest block number of a particular blockchain. Assume the blockchain we choose generates one new block approximately every 1 second, the block chain height synchronization is analogous to the clock synchronization in an operating system. For example, in a computer operation system, every process refers to the clock of the CPU to determine the sequence of the events. Similarly, every node during the learning process can refer to the block height for synchronization and liveness check purposes. For example, if the current block height is block #1,000,000, and we expected every node in the learning task to report their liveness every 3,600 blocks, we will broadcast a request to each node to report its status to confirm it is still alive by block numbers #1,003,600, #1,007,200, and so on. If such liveness acknowledgement was not recorded on the blockchain by the aforementioned block numbers (#1,003,600, #1,007,200, and so on) then such node is determined to no longer be alive. Thus, in one or more embodiments of the invention, the blockchain driver and monitor 102 includes functionality to synchronize the clock of multiple data owners and MPC nodes via the blockchain height.

All nodes subscribe to the chain events, for example a new query is ready, which is sent by the blockchain driver and monitor 102 to the chain and broadcasted to all nodes by the chain. In this scenario, chains serve as an open channel to trigger the critical events among the federated learning process.

Privacy preservation engine 108 and algorithm: In the big data era, data is the most precious resource for each company, usually one company has richest data in its own domain, but barely has any data in other domains. Company likes can benefit from two respects, 1) selling the data to other companies, 2) purchasing data from others to power their own data product. In reality, most companies cannot do this because of the data privacy issues, thus persevering data privacy can be an important design principle. In one or more embodiments of the invention, the privacy preservation engine 108 utilizes variate privacy preservation algorithms to ensure data privacy. These algorithms include and utilize, but are not limited to: 1) Multi-Party Computation (MPC), 2) Differential Privacy (DP) and 3) Homomorphic encryption (RE).

Data preprocessor 114: Each data owner has its own agenda to decide how and where to save the data, when we use the data across different data owners. One practical challenge we will face is how to unify the data schema and data type across multiple sources. It can be impossible or difficult to jointly train one model with multiple data sources. Data preprocessing is the key to solving this issue. The data preprocessor includes functionality to use predefined schemas and data ETL (extract, transform, and load) for processing each data owner's data before starting the training in their local environment. This guarantees data consistency in multiple data sources.

Vertical federated learning module 106: Vertical learning is defined as multiple Data Owners (DOs) having the same users in their database, but each DO can hold different information about users, and can be seen as partitioning by features. For example, assume one DO is a financial company, and another DO is a hospital. An insurance company would like to use data from both DOs to jointly do the underwriting for its consumer's insurance application. The vertical federated learning module 106 includes functionality to join data from multiple DOs and/or to make said data available for training (sometimes across domains). By doing this, the insurance company will have richer data to make the decision. For purposes of this disclosure, this type of application will be referred to as vertical learning, which, in the present example, requires the insurance company to join the data from all DOs first.

Horizontal federated learning module 110: For purposes of this disclosure, horizontal learning involves multiple parties have the same type of information but none of them having the whole population data. For example, the local grocery store X in California only has the shopping history of California residents, and another local grocery store Y, which has the same type of information as X, is located in New York. Combining those two stores' data can enlarge the data set horizontally. The horizontal federated learning module 110 includes functionality to join horizontal data from multiple DOs and/or to make said data available for training.

In one or more embodiments of the invention, the privacy preserved data repository 120 is a data store and service configured to store privacy preserved data including, but not limited to, outgoing data for each data owner and/or encrypted or otherwise anonymized data that is usable for model training. The privacy preserved data repository 120 can be implemented using one or more database management systems (DBMS), a data lake, a structured index, or any other form of data storage that enables storage, search, and retrieval of data by components of the system.

In one or more embodiments of the invention, the training repository 130 is a data store and service configured to store training, test, validation, metadata, and/or any other data relevant to model training. Like the privacy preserved data repository 120, the training repository 130 can be implemented using one or more database management systems (DBMS), a data lake, a structured index, or any other form of data storage that enables storage, search, and retrieval of data by components of the system. In one embodiment, the training repository 130 and the privacy preserved data repository 120 are part of a common data store, or alternatively, reside in separate cloud computing environments connected by a network.

In one or more embodiments of the invention, the model training engine 112 includes functionality to act as a centralized training module for obtaining data from distributed data owners and training a global model using the distributed data. The federated learning platform 100 can be configured to use the model training engine 112 in conjunction with the multi-party computation node(s) 146 in order to perform both distributed and/or centralized training. Alternatively, the model training engine 112 can be utilized to aggregate and combine the results of the local models into a global model that is (optionally) served by the model serving engine 116. In another embodiment, the model training engine 112 does not exist, and multi-party computation node(s) 146 are used exclusively for distributed training.

In one or more embodiments of the invention, the model serving engine 116 includes functionality to execute the model against live production data, and to provide a service application of the model for consumption by one or more internal or external clients. As discussed above, this module (like other modules of the systems described herein) is not required for embodiments of the federated learning process to be executed, either in a distributed or centralized manner.

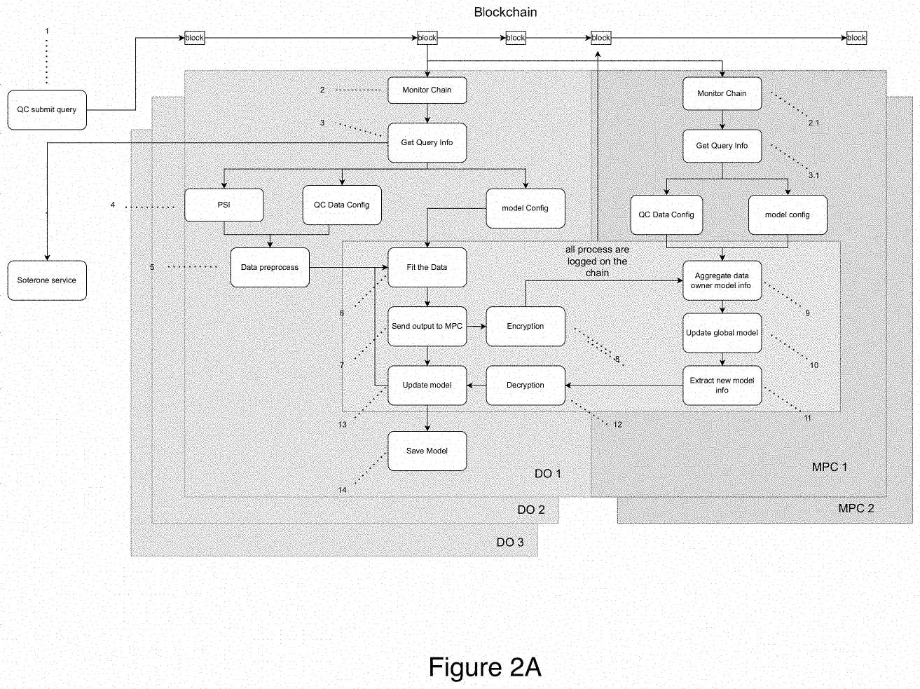

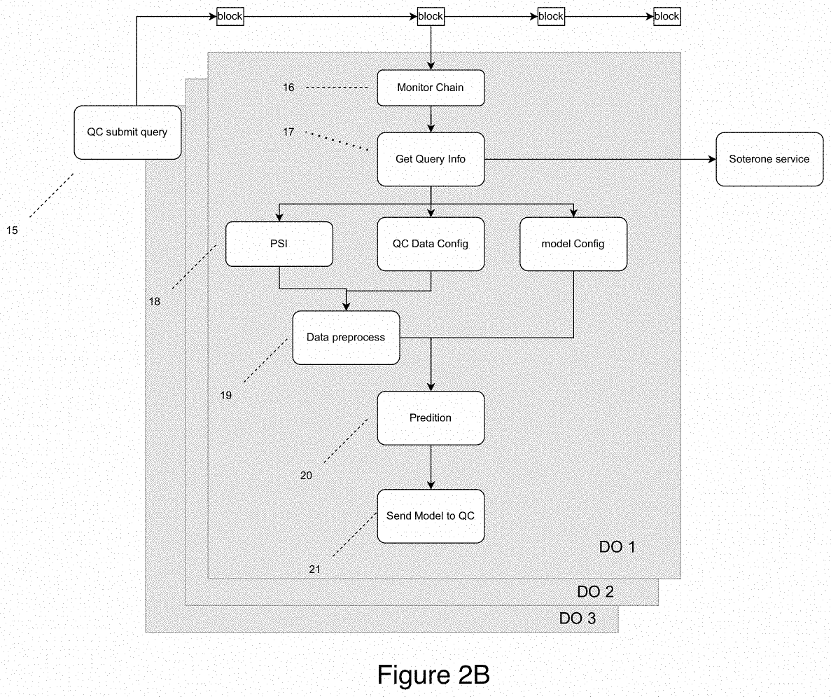

FIG. 2A shows the overview of the machine learning training framework based on the blockchain platform. The framework supports multiple data owners and MPC nodes, in FIG. 2A we mainly demonstrate the specific workflow of one data owner and one MPC nodes, but the other data owners and MPC nodes follow the same workflow. FIG. 2B shows the overview of the machine learning training framework based on the blockchain platform.

In one or more embodiments of the invention, the system comprises the following components: (i) a blockchain driver and monitor 102, (ii) a privacy preservation engine 108, (iii) a data preprocessor 114, (iv) a vertical federated learning module 106, and (v) a horizontal federated learning module 110. The components may be optional, replicated, and/or combined with other systems and components that are not shown, in accordance with various embodiments.

In one or more embodiments of the invention, the blockchain driver and monitor 102 includes functionality to manage and log all federated learning tasks, synchronize multiple data owners and MPC nodes, and/or to display the whole task process on the chain.

In one or more embodiments of the invention, one function of the privacy preservation engine is to protect outgoing data for each data owner.

In one or more embodiments of the invention, the data preprocessor 114 includes functionality to standardize the data type and data schema for each data owner and/or to apply any feature engineering based on the customer's request.

In one or more embodiments of the invention, the vertical federated learning module 106 includes functionality to coordinate the data for each data owner for computing, train/validate/predict the machine learning models in vertical federated learning, and to visualize the train/validate/predict processes.

In one or more embodiments of the invention, the horizontal federated learning module 110 includes functionality to coordinate the data for each data owner for computing, train/validate/predict the machine learning models in vertical federated learning, and to visualize the train/validate/predict processes.

The following describes one or more workflows, in accordance with one or more embodiments of the invention:

1) Blockchain driver and monitor 102: all nodes are subscribing the chain events. For example, the “new query is ready” event is sent by blockchain driver and monitor 102 to the chain and broadcasted to all nodes by the chain. In this scenario, blockchain serves as open channel to trigger the critical events among the federated learning process. The query customer sends a query to the blockchain 1, and each active DO is proactively monitoring the signal on the chain 2. Once the DO are required to join a task, DO can get the query information from the backend service (element 3 of FIG. 2A and/or element 104 of FIG. 1A). During the learning process, we log below information on the chain to ensure the transparency for all users:
Model training/validation loss during each epoch/batch/iteration
Model training/validation metric value
Log information of all the steps in the section labeled “all process are logged on the chain” in FIG. 2A
Data owner/MPC node heartbeats

The following are non-limiting examples of the above data.

Model training/validation loss during each epoch/batch/iteration:

{DO_id: string, model_version: string, loss: float, epoch: int, batch: int, date: datetime}

Model training/validation metric value:

{DO_id: string, model_version: string, metrics: Dict[str, float], epoch: int, batch: int, date: datetime}

Log information of all the steps in the section labeled “all process are logged on the chain” of FIG. 2A:

{DO_id: string, model version: string, epoch: int, batch: int, date: datetime, type: str (starting model fit, send model output to MPC, encryption, aggregate data, update global model, send MPC, output to DO, decryption, update DO model)}

Data owner/MPC node heartbeats:

{DO_id/MPC_id: string, date: datetime s}

2) Privacy Preservation Engine

2.1) Homomorphic encryption (HE): Homomorphic encryption can let the mathematical operations applied on the encrypted text and get the same result as the plain text. Thus, the HE algorithms are variated based on what kind of mathematical operation is going to apply on encrypted text. In the current framework, we use Paillier encryption, and the scheme works as follows:

a) Key generation: Using large prime numbers to generate a pair for public and private keys for encryption and decryption. The public (encryption) key is (n,g), and the private (decryption) key is (λ,μ).

b) Encryption 8: Select random number r and compute ciphertext with random number plaintext and public key. The formula is: c=g^{m}·rⁿ mod n², and the m is the plaintext.

c) Decryption 12: Use public and private keys to compute the plaintext message. The formula is: m=L(c^{λ}mod n²)·μ mod n, and c is the ciphertext.

2.2) Multi-Party Computation (MPC): Secure multi-party computation (also known as secure computation, multi-party computation (MPC), or privacy-preserving computation) is a subfield of cryptography with the goal of creating methods for parties to jointly compute a function over their inputs while keeping those inputs private. Unlike traditional cryptographic tasks, where cryptography assures security and integrity of communication or storage and the adversary is outside the system of participants (an eavesdropper on the sender and receiver), the cryptography in this model protects participants' privacy from each other.

In one or more embodiments of the invention, a Secret Sharing with SPDZ protocol is used. This can refer one or more methods for distributing a secret among a group of participants to allocate a share of the secret among the group of participants. The secret can only be reconstructed when the shares are combined together; individual shares are of no use on their own.

3) Data Processor (See element 5 of FIG. 2A)

In one or more embodiments of the invention, in order to learn multiple data sources (i.e., multiple data owners), the first step of the federated learning framework is to properly load the data from different data sources, such as relational database, non-relational database. Because different data owners choose different databases based on their needs, providing a single unified API for ML-SDK to load the data is critical. The data source API can support load and write functions to both popularly relational databases and non-relational databases, and convert the data to common data format in Python. The federated learning framework can be configured to support various data repositories including, but not limited to, Redshift, MySQL, Hadoop, HIVE, and Amazon S3 file system. Various data formats can also be supported including, but not limited to, Pandas dataframe, Spark dataframe and Numpy array.

Data processor is used to process the raw data from each DO to sanctify the QC data requirements. The data processor has the basic functionality for converting numeric data and categorical data into a desired format including:

a. Numeric data: (i) Standard scale: scale the data into standard normal distribution, (ii) 0-1 scale: scale the data within specified lower and upper bound, (iii) Bucketization: convert numeric data into multiple ranges

b. Categorical data: (i) One-Hot encoding: create a binary column for each category and return a sparse matrix with 1s and 0s.

4) Horizontal Learning

Horizontal learning is applied when multiple parties have the same type of information but none of them have the whole population data. The combination of those data can enlarge the data set horizontally. Horizontal learning can utilize the advantages of big data without privacy concern. In one embodiment of the federated learning framework, the horizontal learning works as follow:

4a) The Query Customer (QC) sends the data and model requirements to the backend service (BS, e.g., element 3 of FIG. 2A and/or element 104 of FIG. 1A), and the backend service further sends the information of the event to the chain to notify the Data Owners (DOs) (See element 1 of FIG. 2A).

4b) DOs monitor the chain and retrieve the event's information to query corresponding data, model requirements from BS (See elements 2 and 3 of FIG. 2A).

4c) Dos process the data according to the data requirement, and build the model based on the model requirement (See element 5 of FIG. 2A).

4d) DOs load data and trains the model locally (See element 6 of FIG. 2A).

4e) DOs send the encrypted training intermediate data to the MPC node (See element 7 of FIG. 2A).

4f) MPC node collects all DOs' encrypted data and trains the model globally (See element 9 of FIG. 2A).

4g) MPC node adds DP on the global data and send it back to each DO (See element 11 of FIG. 2A).

4h) DOs receive the MPC data and update the local model (See element 13 of FIG. 2A).

4i) Iteratively goes through processes d to h, until the stop criteria are met.

4j) DOs send the local model back to BS, and BS notifies the QC the task is done (See element 14 of FIG. 2A).

In the above process, we can successfully prevent privacy leak in all three parties, namely, QC, DOs and MPC node. Firstly, from the perceptive of QC, the gradient upload to MPC node is encrypted, so MPC node can't attack QC's data. MPC node sends the DP encrypted aggregated gradient to DO, so DO can't attack QC's data by gradient. Secondly, from the perspective of MPC node, since the model and gradient are applied with secret sharing, the MPC won't know which kind of model DO is building, or any information related to the data. Thirdly, from the perspective of DO, the gradient adds DP noise, thus QC can't attack DO's data by gradient. Thus, the data privacy is preserved.

5) Vertical Learning: Vertical federated learning or feature-based federated learning is applicable to the cases that two data sets share the same sample ID space but differ in feature space. By combining multiple parties' data, it can enlarge the breadth of the dataset owned by QC and provide a multi-angle view of the data. The vertical learning process is in the following:

5a) Perform Private Set Intersection (PSI) (See element 4 of FIG. 2A)

PSI is a secure multiparty computation cryptographic technique that allows two parties holding sets to compare encrypted versions of these sets in order to compute the intersection. In this scenario, neither party reveals anything to the counterparty except for the elements in the intersection. The steps of PSI are:

1) The Query Customer (QC) sends the event's information to the chain to notify Data Owners (DOs).

2) MPC node designs the PSI plan and publishes to the Chain.

3) DOs monitor the chain and retrieve the PSI plan to find the common data samples across all the DOs and QC (i.e., the final PSI result is in QC)

5b) Perform Training:

1) The Query Customer (QC) sends the PSI result, data, model requirements to the Backend Service (BS, e.g., element 3 of FIG. 2A and/or element 104 of FIG. 1A), and BS further sends the event's information to the chain to notify the Data Owners (DOs) (See element 1 of FIG. 2A).

2) DOs monitors the chain and retrieve the event's information to query corresponding PSI result, data, model requirements from BS (See elements 2 and 3 of FIG. 2A).

3) DOs processes the data according to the PSI result, data requirement, and builds the model based on the model requirement (See elements 4 and 5 of FIG. 2A).

4) Dos load data and trains the model locally (See element 6 of FIG. 2A).

5) DOs send the encrypted training intermediate data to the MPC node (See element 7 of FIG. 2A).

6) MPC node collects all DOs' encrypted data and trains the model globally (See element 9 of FIG. 2A).

7) MPC node adds DP on the global data and sends it back to each DO (See element 11 of FIG. 2A).

8) Each DO receive the MPC data and update the local model (See element 13 of FIG. 2A).

9) Iteratively goes through processes iv to viii, until the stop criteria are met.

10) DOs send the local model back to BS, and BS notifies the QC of the completion of the task (See element 14 of FIG. 2A).

5c) Prediction

1) The Query Customer (QC) sends the PSI result (Optional), prediction data, trained sub model to the Backend Service (BS, e.g., element 3 of FIG. 2A and/or element 104 of FIG. 1A), and BS further sends the event's information on the chain to notify the Data Owners (DOs) (See element 1 of FIG. 2A).

2) Run PSI process for the prediction data. If the prediction data already goes through the PSI stage previously, this process can be skipped (See element 4 of FIG. 2A).

3) DOs monitor the chain and retrieve the event's information to query corresponding PSI result, data, model from BS (See elements 2 and 3 of FIG. 2A).

4) DOs load data and perform the prediction locally (See elements 5 and 6 of FIG. 2A).

5) DOs send the partial prediction results to the QC (See element 7 of FIG. 2A).

6) QC combines the DOs' prediction to get the final prediction.

5.1) Private Set Intersection (PSI) (see element 4 of FIG. 2A): The private set intersection (PSI) in the Federated Learning Framework is used for the data owners to get the intersection of their data without leaking other data and preserves the data privacy during data exchange. In one embodiment of the invention, we use RSA Blind Signature-based PSI. The following is an exemplary workflow:

Part A: Base Phase

1) The Server generates RSA private key d (for Server to sign data), public key e and RSA modulus N (product of two big prime, p*q), and then sends e and N to the client.

2) The client generates m (m is the size of Client's set) random number [r1, r2 . . . , rm] (r is less than N), then generates r_inv and r′ for blinding and unblinding the client's set.

Part B: Online Phase

1) The server uses private key d to sign its own set, then insert it into a new bloom filter. The server then further sends the bloom filter to the client.

2) The client blinds its data by r′ and N, and then sends the data to the server.

3) The server uses private key d to sign the data received from the client, and then sends it back to the client.

4) The client receives the signed data from the server and unblind it using r_inv and N, and then checks which element is in the bloom filter by the bloom filter's function Check( ). Finally, the elements that exist in the bloom filter are the intersection of the server with the client.

Data Standardization Scheme

This disclosure describes systems and methods of a data platform that supports multiple data owners collaboratively working on a single task. Most of the existing federated machine learning frameworks assume the data is clean and preprocessed before loading into the framework, thus they focus more on the modeling and communication between each data source. But in the real world, this assumption is not valid, as the data could be dirty, unstructured and unprocessed. Hence, current federated learning frameworks cannot be applied in the large-scale real-world applications. To solve this problem, one or more embodiments of the invention utilize a data platform which is driven and maintained by users and data transformers of the system, to collaboratively clean and preprocess the data. Our data platform contains a data store that saves the metadata of data owners' data, is published and searchable. The data store supports three operations: create, update, and get. Each data owner can add new metadata or update the existing metadata of a specific data in the data store. The data transformers in our data platform can pull the latest metadata from the data store and transform data owner's data accordingly.

FIG. 1B shows a data standardization module 150, in accordance with one or more embodiments. As shown in FIG. 1B, the data standardization module 150 includes (i) a metadata store 156, (ii) a data source loader 152, and (iii) a data transformer 154. The data standardization module 150 may be a component of or include integration with previously described federated learning platform 100 of FIG. 1A. The components may be optional, replicated, and/or combined with other systems and components that are not shown, in accordance with various embodiments. In one or more embodiments, data platform is configured to perform federated learning in various different configurations and optional embodiments.

FIGS. 2A and 2B show a data platform and flow diagram, in accordance with one or more embodiments. As shown in FIGS. 2A and 2B, the data platform includes the components of FIG. 1B, namely, (i) a metadata store, (ii) a data source loader, and (iii) a data content transformer. The data platform may be a component of or include integration with previously described federated learning platform 100 of FIG. 1A. Like FIG. 1A, the data platform integrates with one or more blockchain nodes, one or more query customers, one or more data owners, and/or one or more multi-party computation nodes (MPCs). The components may be optional, replicated, and/or combined with other systems and components that are not shown, in accordance with various embodiments. In one or more embodiments, data platform is configured to perform federated learning in various different configurations and optional embodiments.

In one or more embodiments of the invention, the data standardization module 150 includes functionality to operate on raw data, or data prior to preprocessing. Thus, the following is an exemplary workflow: Raw Data→Data Standardization Module 150→Data Preprocessor 114→Feed to Model

Metadata store 156: The goal of our data platform is to unify the same types of information to be consistent across all data owners. For example, for the gender information, users can save it as ‘female’ or ‘male’, ‘F’ or ‘M’, ‘0’ or ‘1’. Besides the specific content the user saved, uses can also the column name in different terms, such as ‘sex’, ‘gender’, ‘user_gender’. This is a non-trivial job, because it is hard for us to predefine or foresee all the possible situations in the real world and building a heuristic and user driven solution is more important for us. In our data platform, we maintain a public metadata store, which is available and can be modified by all users. Users have the freedom to add new columns that do not exist in our data store and can add new content in our existing column. For example, when a new data owner A joins our platform, it has educational information which other data owners do not have. The data owner A will create a new field in our data store to save the metadata into our public data store, and it can create a new column that names ‘education’ and add unique values in this column, such as ‘elementary school’, ‘middle school’, and ‘high school’. Later on, another data owner B joins in our network with educational data, but the users in B have a higher-level educational background which does not exist in our data store, then B can update the ‘education’ metadata, such as adding ‘bachelor’, ‘master’. Now the ‘education’ metadata contains ‘elementary school’, ‘middle school’, ‘high school’, ‘bachelor’, and ‘master’.

In one or more embodiments of the invention, the metadata store 156 is a data store and service configured to store data defined, configured, and/or provided by data owners, including, but not limited to, the above examples. The metadata store 156 can be implemented using one or more database management systems (DBMS), a data lake, a structured index, or any other form of data storage that enables storage, search, and retrieval of data by components of the system.

Data source loader 152: Data source loader is a unified API that supports loading data into Python panda data frame, and Spark data frame from different databases and file types. Users only need to define the database, file type, credential and selected columns in the configuration file. Our data source loader can automatically read and parse the configuration file and load the data from the defined local/database into the user's local computing environment.

Data transformer 154: The data transformer is used to transformer the same content into the same format for multiple data owners. Once we have built the public metadata to save data owner's contents info, the next step is to use it to unify the data content. Each data owner first needs to check if our metadata store has its all-column metadata, then use the metadata to build a data configuration which is used to map the customized data owner content to the network standard content. Taking the previous educational data as an example, when a new data owner C joins our platform, C also has the educational data, but it saves the data in a different way. For example, the ‘bachelor’ and ‘master’ in C are saved as ‘university’ and ‘graduate’. The data owner C needs to add ‘university’->‘bachelor’ and ‘graduate’->‘master’ in the data content transformer configuration for education column. Once all the data owners follow the same metadata, it will guarantee data consistency across all the data owners.

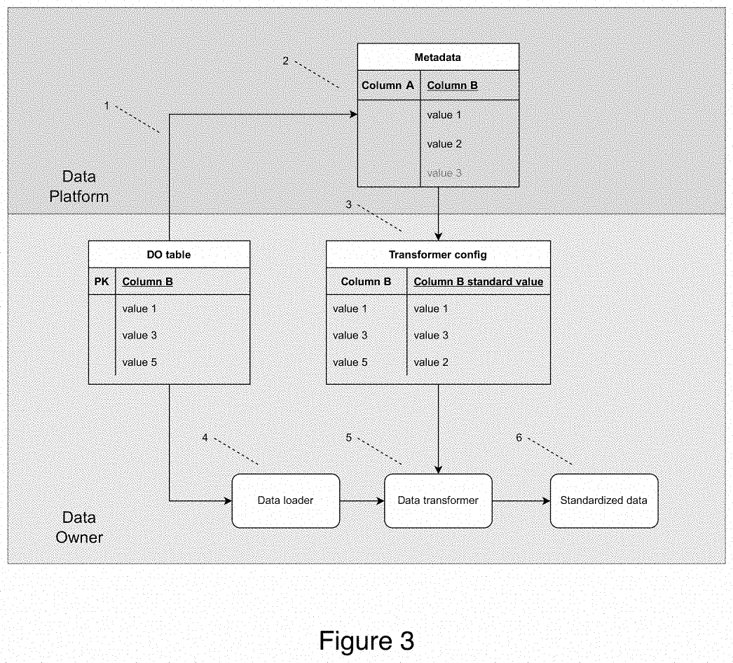

FIG. 3 illustrates an overview of how data owners can utilize the data transformation API to get the standardized data in the data platform.

In one or more embodiments of the invention, further to the description above, the metadata store includes functionality to maintain the data format and data content for all available data in the platform. The metadata store can also be configured to provide the standardization of data.

In one or more embodiments of the invention, further to the description above, the data source loader includes functionality to support loading data from multiple different data sources and file formats.

In one or more embodiments of the invention, further to the description above, the data content transformer includes functionality to standardize the data type and data schema for each data owner.

1) Build Metadata Store

The first thing after a data owner joins the data platform is to update its data schema with the metadata store. There are two actions for the data owner, 1. Add a new metadata of a data column, 2. Update the existing data column metadata. The process is listed in the below:

STEP 1: Look up the public metadata store 1 and find if there is a column that exists. STEP 1a: If not, submit a request to the data platform with the new column name and the metadata.

STEP 2: If the column exists, then check if there is new information that not include in the metadata need to be added. STEP 2a: If yes, submit the new metadata info to data platform 2.

2) Load and Transformer Data

Once the data owner registers and synchronizes the data platform, the data owner can join the computing task with other data owners. The data owner needs to verify its data content with the data platform metadata and build metadata configuration to map its data to the data platform standard content 3. After building the metadata configuration, the data owner will follow the below steps to start the computing task:

STEP 1: The data loader loads the data from the data owner database or local path 4.

STEP 2: The data content transformer loads the configuration and standardizes the data for the data owner when loading the data for any query task 5, 6.s

Multi-Party Computation with Secret Sharing

Systems and methods in the present disclosure investigate a novel privacy problem in the Federated Learning algorithm. One or more embodiments of the invention are directed towards the collaboration of multiple data owners training a logistic regression. A Multi-Party Computation secret sharing scheme is disclosed to protect the data owners' data during the training process. This successfully removes dependence of the trust server which is required by the homomorphic encryption (HE) scheme to train the logistic regression under the federated learning setting.

One or more embodiments of the invention provide a solution for multi-party collaborative learning on a logistic regression under Multi-Party Computation and a novel secret sharing scheme. Embodiments of the invention secure against an honest-but-curious adversary. The implementation can achieve the same or similar accuracy to a naive non-private learning on logistic regression when all data are in one place, and it can scale to industry level data size.

In various embodiments of the invention, enhancements to federated logistic regression include, but are not limited to:

(i) Removing dependence on the trust server. This allows joint learning to happen among multiple data owners without exposing data in plaintext. In one embodiment of the invention, only the data owner can access its own data.

(ii) aggregate computation is on the plaintext powered by secret sharing, which is more efficient than computing on the ciphertext.

Secret sharing: Secret sharing is a method to split a secret into multiple partitions and allocate a share of the secret to one party. The secret only can be reconstructed when a sufficient number of parties combine their share together. Each single party cannot use or reconstruct the secret. For example, in one type of secret sharing scheme, there is one secret holder and n parties. The secret holder can divide the secret into n mutually exclusive parts and randomly assign to each party. In this way, if any group of t or more parties can reconstruct the secret together, but no group of fewer than t parties can, this is called a (t, n)-threshold scheme. In our algorithm, we choose the SPDZ protocol. SPDZ allows us to have as few as two parties computing on private values, and it is popular in the past few years with several optimizations that are known that can be used to speed up the computation.

The process of logistic regression gradient descent with secret sharing:

The loss function of binary logistic regression is:

$$J ( θ ) = - \frac{1}{m} {\sum }_{i = 1}^{m} {y}^{i} log ( {h}_{θ} ( {x}^{i} ) ) + ( 1 - {y}^{i} ) log ( 1 - {h}_{θ} ( {x}^{i} ) )$$

Where θ is the parameter of logistic regression, y is the true label, h_{θ}(xⁱ) is the logistic regression. Plugging in the simplified expression of the logistic regression, we obtain:

$$J ( θ ) = - \frac{1}{m} {\sum }_{i = 1}^{m} [ - {y}^{i} ( log ( 1 + {e}^{- {θx}^{i}} ) ) + ( 1 - {y}^{i} ) ( - θ {x}^{i} - log ( 1 + {e}^{- θ {x}^{i}} ) ) ]$$

Taking −θxⁱ−log(1+c^{-θx}^{ⁱ})=−[log e^{θx}^{ⁱ}+log(1+e^{-θx}^{ⁱ})]=−log(1+e^{θx}^{ⁱ}) into above function, it can be simplified as:

$$J ( θ ) = - \frac{1}{m} {\sum }_{i = 1}^{m} [ {y}_{i} θ {x}^{i} - θ {x}^{i} - log ( 1 + {e}^{- θ {x}^{i}} ) ] = - \frac{1}{m} {\sum }_{i = 1}^{m} [ {y}_{i} θ {x}^{i} - log ( 1 + {e}^{θ {x}^{i}} ) ]$$

In order to operate under the constraints imposed by the secret sharing scheme, we need to approximate the logistic loss and the gradient. To achieve this, we take a Taylor series expansion of log(1+exp(−z) around z=0:

$$log ( 1 + exp ( x ) ) = log ( 2 ) + \frac{x}{2} + \frac{{x}^{2}}{8} - \frac{{x}^{4}}{192} + O ( {x}^{6} ) \qquad$$

The second order approximation of logistic loss is:

$$J ( θ ) = - \frac{1}{m} {\sum }_{i = 1}^{m} [ {y}^{i} θ {x}^{i} - log ( 2 ) - \frac{1}{2} θ {x}^{i} - \frac{1}{8} {( θ {x}^{i} )}^{2} ] \qquad$$

Now we take the derivative of the loss function respect to the

$$\frac{\partial J ( θ )}{\partial {θ}_{j}} = - \frac{1}{m} {\sum }_{i = 1}^{m} [ {y}^{i} - \frac{1}{2} - \frac{1}{4} θ {x}_{i} ] {x}_{i}^{j}$$

Now let's assume we have two parties A and B hold two set of features, and party A has the target variable, here is how we apply secret sharing on the gradient to update the model:

θxᵢ=θ_{A}x_{A}+θ_{B}x_{B}

θ_{A}x_{A}=(θ_{A}x_{A})_{mpc1}+(θ_{A}x_{A})_{mpc2}+(θ_{A}x_{A})_{mpc3};

θ_{B}x_{B}=(θ_{B}x_{B})_{mpc1}+(θ_{B}x_{B})_{mpc2}+(θ_{B}x_{B})_{mpc3}

MPC₁=y_{mpc1}−½−(¼(θ_{A}x_{A})_{mpc1}+(θ_{B}x_{B})_{mpc1})

MPC 2 and MPC 3 have the same function as above.

$$\frac{\partial J ( θ )}{\partial {θ}_{a}} = ( M P {C}_{1} + M P {C}_{2} + M P {C}_{3} ) {x}_{A}$$

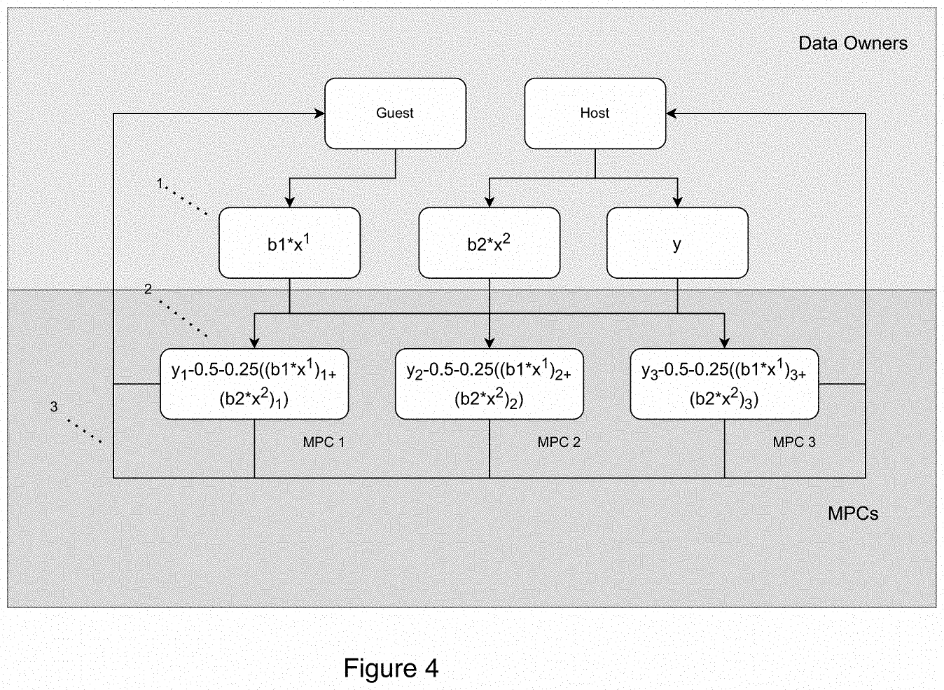

FIG. 4 shows an exemplary depiction of the secret sharing scheme, with guest and host data owners sharing private data. In this example, the data owner parties (the guest and the host) compute the logistic regression parameter θ and use the secret sharing to split the raw data into different data partitions.

In one or more embodiments of the invention, the data owner parties (the guest and the host) use the random filter to get the MPC partitions, i.e., randomly decide which MPC nodes to send over the data partitions.

In one or more embodiments of the invention, the data owner parties (the guest and the host) get the returned MPC gradients from each MPC nodes.

In one or more embodiments of the invention, the data owner parties (the guest and the host) compute the global gradient from the aggregation from each MPC gradients.

In one or more embodiments of the invention, the MPC nodes collect all data and label partitions from each data owner.

In one or more embodiments of the invention, the MPC nodes aggregate all data partitions to compute partial gradient;

In one or more embodiments of the invention, the MPC nodes send aggregated gradient back to data owners. s

Flowcharts

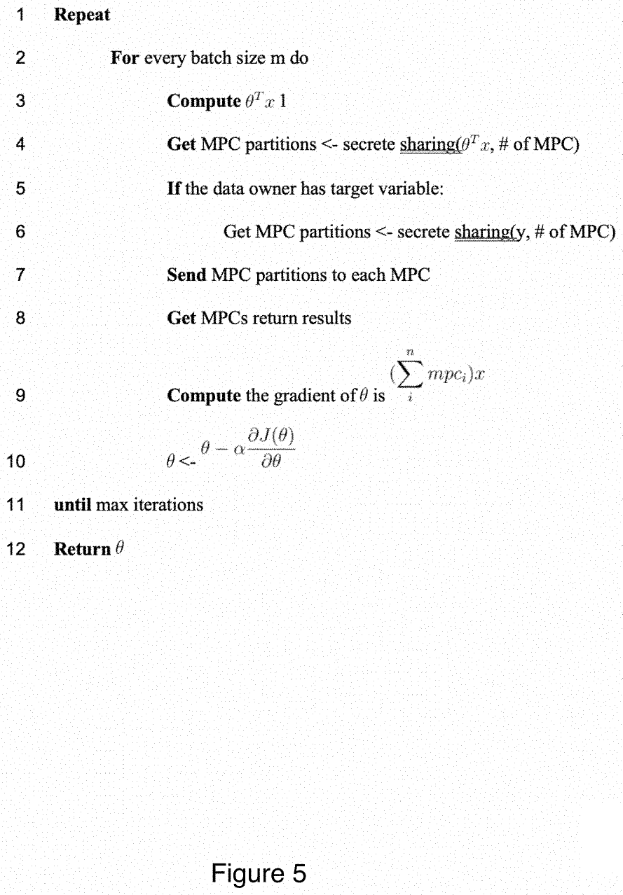

FIG. 5 shows an algorithm for logistic regression on data owner side. While the various steps in this algorithm are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in the algorithm of FIG. 5 should not be construed as limiting the scope of the invention.

The algorithm has an outer loop which repeats until reaching a predefined maximum number of iterations. Inputs to the algorithm are the learning rate a, MPC's IP address, batch size, and max iteration. The output of the algorithm is the model θ.

The parameter for logistic regression, the secret sharing function, and the connection to the MPC server must all be initialized prior to being utilized.

The process obtains the training data from the data owner and multiply with linear model coefficients to get the model prediction. The process then splits the above data by the number of MPC nodes. Since we have multiple data owners, some of them may only provide features, while some of them may have labels. If the data owner has labels, the process also splits the labels into the number of MPCs.

The process then proceeds by randomly sending one copy of the partitioned data to an MPC. The MPC then computes the partial gradient and returns the result to the Host. Finally, the host updates the model coefficients

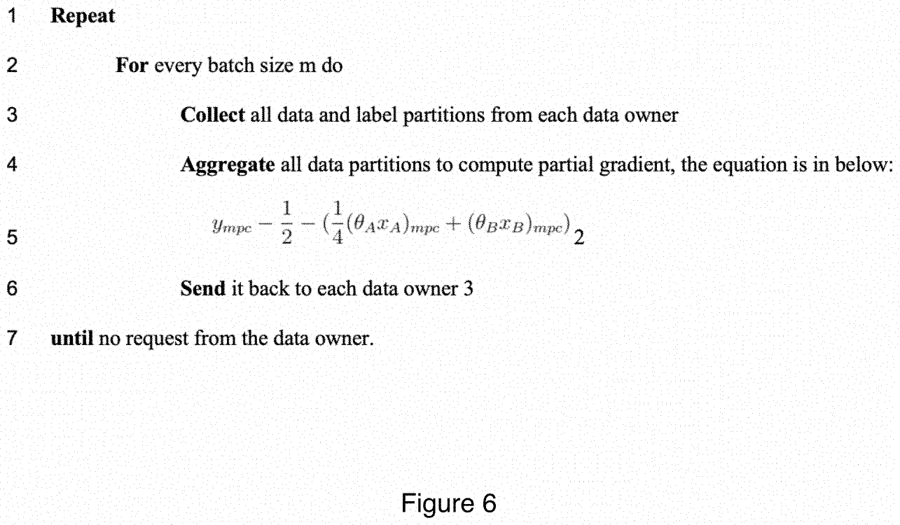

FIG. 6 shows an algorithm for logistic regression on the MPC side. While the various steps in this algorithm are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in the algorithm of FIG. 6 should not be construed as limiting the scope of the invention.

The algorithm has an outer loop which processes requests from the data owner(s) until completion. The data owner's IP address is an input to the algorithm. The MPC server must be initialized prior to being utilized.

The process begins by data owners sending the partitioned prediction and label to each MPC. The MPCs use the partitioned predictions to compute the partial gradient for the model to update the coefficients. Each MPC sends the partial gradient back to the Host.

In one or more embodiments, methods for performing logistic regression (e.g., the algorithms of FIGS. 5 and 6) may be performed either sequentially or in parallel. It should be appreciated that in one or more embodiments, the steps of FIGS. 5 and 6 can be executed by the same or different module(s) (or processors) from the module(s) (or processors) of the above-described systems.

Proof of Reputation

A safe and orderly blockchain requires us to solve two fundamental problems: double spending and the Byzantine Generals Problem. Double spending problem means to reuse the currency in two transactions simultaneously. The Byzantine Generals Problem refers to the possibility that, during the peer-to-peer communication of the distributed system, some malicious user may tamper with the communication contents, thus leading to security breach or communication inconsistency.

In order to make the whole blockchain safe and consistent, the generation of blocks needs to reach a certain consensus, and the consensus algorithm is one of the keys to blockchain technology. The common consensus algorithms are PoW, PoS and DPoS. They are distributed in the three dimensions of efficiency and energy consumption, centralization and security.

PoW (Proof of Work): The workload proof mechanism, through a large number of HASH operations, calculates a suitable random number and produces a new block. And this is the most secure way of security, but at the same time, it is also very energy consuming. Bitcoin is the most typical PoW implementation.

PoS (Proof of Stake): The ownership proof mechanism, through the holding amount and holding time of the token, reduces the difficulty of the block production. This method solves the problem of energy consumption compared with PoW, but there are certain bottlenecks in security, and system bifurcation is easy to appear.

In the original design of PoW, it is the hope of the designer that all mining workers can use the CPU to mine such that each node, even with different computing power (thus different hashing power), still has the equal opportunity to participate in the decision-making of the blockchain. However, with the development of the hardware such as GPUs and ASICs, and the aggregation of individual computing power into mining pools, the ordinary miners rarely have the opportunity to create a block.

Recently, there are more and more criticisms of PoW not being environmentally friendly and a huge waste of tremendous computing power that could be used elsewhere. One such field that requires great computing power is secure multi-party computation (MPC) and machine learning (ML). Some research predicts the amount of computing power needed in MPC and ML has been increasing exponentially with a 3.4-month doubling time. Such training results help academia and industries to have better trained modeling for medical research and advanced technologies such as robotics, self-driving technology, and space exploration.

We are motivated to propose a new consensus scheme, Proof and Reputation (PoR), to incentivize the miners to contribute to the computing needs of MPC and ML.

This disclosure describes a consensus algorithm proof of reputation (PoR) that can be used for block chain which coordinates the federation learning. The present disclosure first describes the design layers of block chain nodes and the relationship among them. Then it describes the node role evolution workflow and how the consensus layer is activated to contribute to chain block making. Finally, it describes the details of consensus protocol, incentive mechanism and how it integrates with federation learning to get the reputation scores.

Proof of Reputation (PoR) is a new consensus and reward scheme for any blockchain platform. The PoR scheme combines the efficiency of PoS and incentive miners to simultaneously participate in the MPC computing. The high-level idea is to have a cluster of P2P nodes and register them as the MPC computing nodes. Each of the nodes is further registered and approved as the consensus nodes candidates. From there, some candidates will be selected as the validators and one node will be selected as leader for round N in the time spectrum. Thus, validators and the leader will have dual roles: The validators/MPC nodes roles are to get reward from the validation process and the MPC computing process, respectively. The reward will be calculated at the end of round N, with both of the token rewards from consensus validation and the MPC node computation. Any unfinished middle-way MPC computing will be recorded in the smart contract and resume in the round N+1.

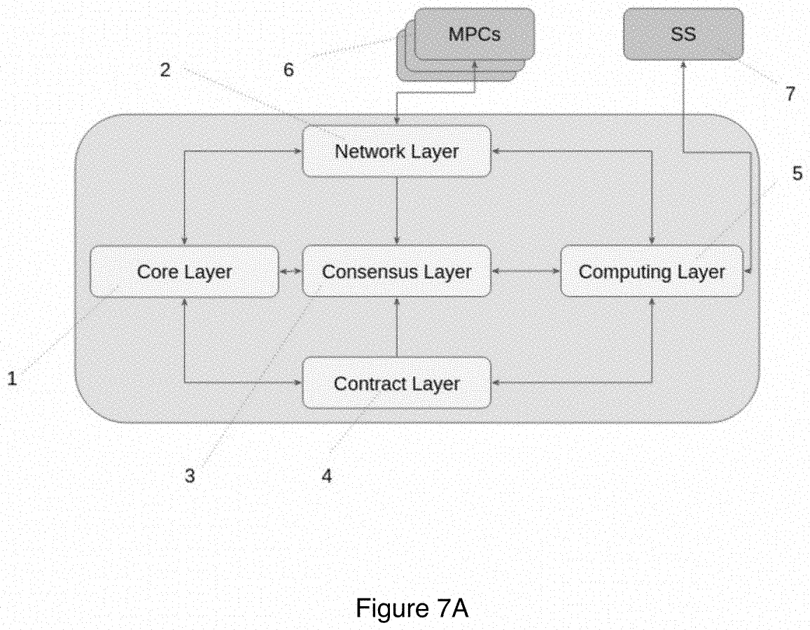

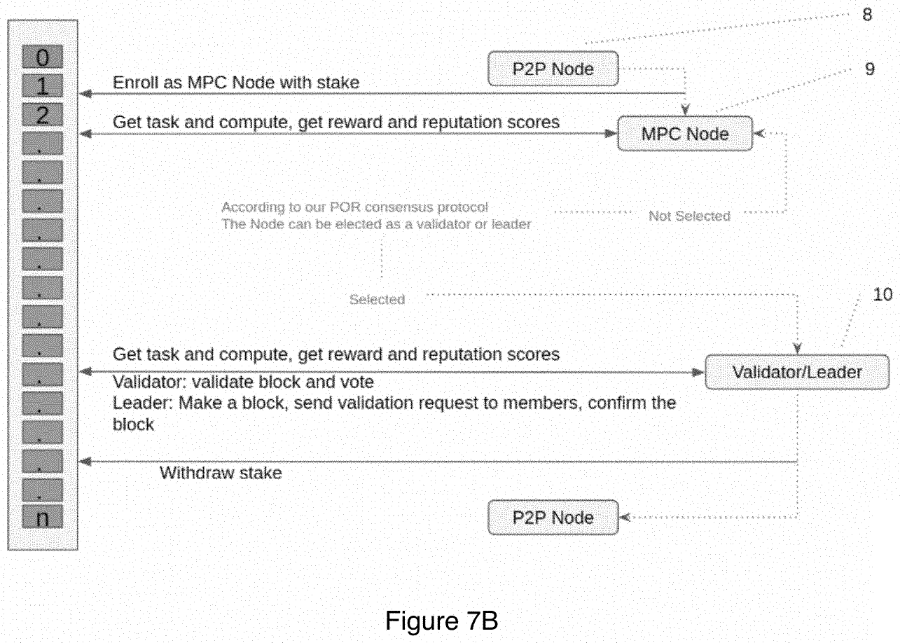

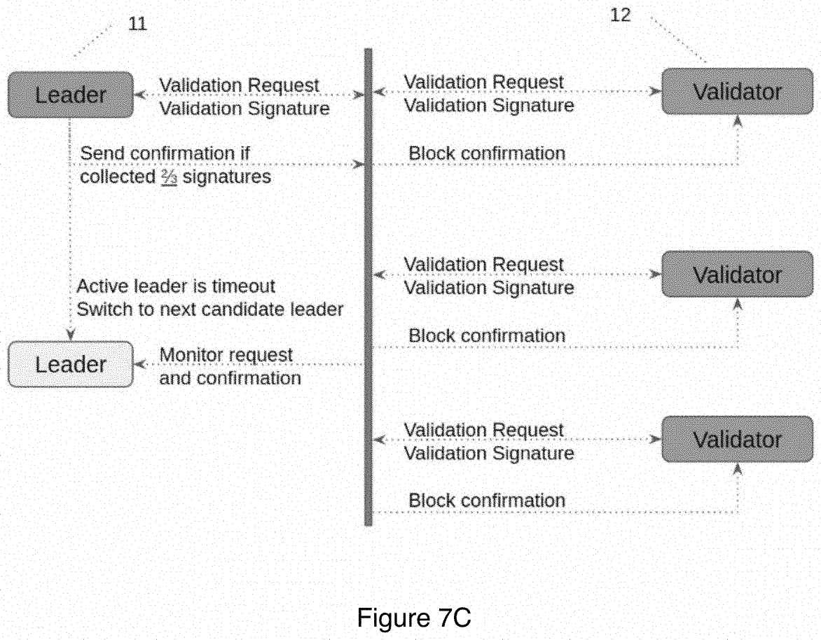

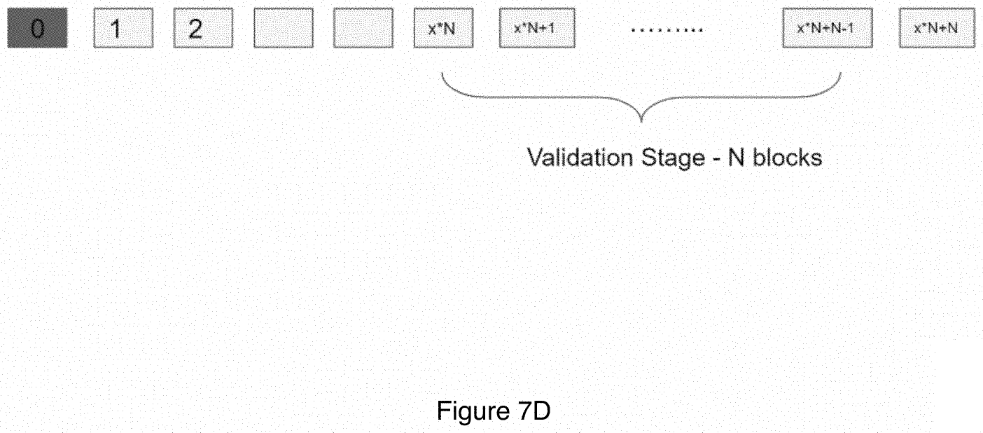

FIG. 7A depicts a proof of reputation system, in accordance with one or more embodiments. As shown in FIG. 7A, the proof of reputation system includes a core layer, a consensus layer, a computing layer, a contract layer, and a network layer. The system may also include integration with one or more one or more multi-party computation nodes and a backend service (SS). In one or more embodiments, the system is configured to perform proof of reputation consensus in various different configurations and optional embodiments.

Core layer functionality: Manage level db, Merkle Tree, Read/Write Block, Computing hash, construct block

Network layer functionality: P2P network, discover p2p node, sync chain state, RPC/WS service, Consensus protocol network layer

Consensus layer functionality: PoR protocol, Block validation request, Block validation, Block confirmation, Mange the incentive for validator, Manage the rewards for MPC computing

Contract layer functionality: Hold the precompiled Smart Contract, MPC node management, Validator/Leader management, MPC tasks management, Hold user deployed Smart Contract

Computing layer functionality: MPC computing for data owners, Run tasks from chain, Get data from Controller, Send back result to Controller, Update status on chain

Other MPCs functionality: Computing and blockchain party

Backend service functionality: Coordinate all MPCs to complete the computing via block chain, Calculate the reputation score of each node as follows:

$${Rep}_{next} = {Rep}_{cur} + γ Q ( α {QC\_Feedback}_{t} + {βSS\_Eval}_{t} , {Rep}_{cur} )$$

FIG. 7B depicts a proof of reputation flow diagram, in accordance with one or more embodiments. As shown in FIG. 7B, the proof of reputation flow includes a P2P Node, an MPC Node, a validator, and a leader. In one or more embodiments, the system is configured to perform proof of reputation consensus in various different configurations and optional embodiments.

P2P Node functionality: Run as a chain full node, sync blocks from other nodes.

MPC Node functionality: Enroll on the chain, register its computing component, and monitor the training tasks.

Validator functionality: Respond to the validation request as well as computing

Leader functionality: Make block, send validation request and confirm the block, at the same time run computing

Workflow

Referring back to FIG. 7B, each node has four modes, P2P node 8, MPC node 9, Validators and Leader 10. When the node starts, it automatically goes into P2P mode, which syncs chain state from discovered P2P nodes. Once the personal account is set, and stake in the transaction has been sent, the node will go into MPC mode and monitor events which related to it. Now it can receive computing tasks. If the tasks are computed successfully, the personal account will get a reward, but if the task cannot be computed correctly or node does not send back the result in a specific time window, the node's reputation will drop, with potential penalty of its stake in tokens.

Once the MPC node gets a high reputation score, it has the chance to be elected as a validator or leader. The Leader role, besides computing, will have more responsibility such as making a new block which encapsulates transactions from its transaction pool, sending the block to other validators to validate. Once the leader collects enough validation response, the confirmation will be attached to the block, so other P2P nodes will add the block to its own chain. The Validator needs to respond to any validation request as well as computing.

Consensus Protocol

FIG. 7C depicts a proof of reputation flow diagram, in accordance with one or more embodiments. As shown in FIG. 7C, the proof of reputation flow includes interaction between the validator(s) and leader. In one or more embodiments, the system is configured to perform proof of reputation consensus in various different configurations and optional embodiments.

Here is the workflow of the consensus protocol.

Firstly, in the validation Round, we define that the Leaders 11 and Validators 12 will shift every N blocks, to simplify the control, and the block height is aligned N. As such, for validation round x, the left block is x*N, the right block is x*N+N−1.

Secondly, we will update each node's reputation score. in block x*N to x*N+N−1, MPC Node's reputation score might be changed because of its contribution to computing. The consensus layer will evaluate each MPC node's reputation score based on historical computing and validation, to select the active Validators for next validation round, and finalize at the block x*N+N−1. At the same time, Consensus Layer will select the node with the highest reputation score as the leader.

Thirdly, for each block, the leader generates the blocks, sends validation requests to all validators, and then waits for the validation signatures. Once validation signatures reach ⅔ of validators, the leader will send confirmation, so that the block is confirmed on the chain. Suppose there are ⅔ honest validators and no network issues, if the active leader crashes somehow, or it is not currently available, all validators cannot get the block confirmation in a specified time. In this case, the node with the second highest reputation score will take over the responsibility automatically to generate new blocks.

Last but not the least, once the whole validation round is complete, the incentives will be distributed to all validators and leaders based on their reputation scores.

Incentive and Reward Scheme

FIG. 7D depicts a proof of reputation flow validation stage of a blockchain, in accordance with one or more embodiments.

In our genesis block, the mining incentive will be set as 1E8 Token, the chain will make a block about one second. Mining one block can get 0.4 Token for the first 4-years, and 0.4*½ tokens will be rewarded for the following 4 years, and so on so forth. The incentive of mining one block will be halved for every 4 years. The 1st 4-year incentive tokens

T₁=0.4×3600×24×365=50457600

T₂=0.4×0.5×3600×24×365=25228800

T₃= . . .

T=T₁+T₂+T₃+ . . . +Tₙ=2×(T₁−Tₙ₊₁) [symbol] T₁

At the block x*N, the validation group has been formed, and we assume there are n nodes with n−1 validators and 1 leader. In the validation round x, suppose the reputation credit score for each validator is Sᵢ, where i=1−n−1, and n is the leader. The leader has an extra factor [symbol] >1), and its credit scores are [symbol] Sn. Suppose R_{b} is the incentive for mining a block, each validator reward will be:

$${R}_{i} = \frac{{S}_{i}}{{Σ}_{1}^{n - 1} {S}_{i} + α \times {S}_{n}} \times ( {R}_{b} + {Fee}_{tx} )$$

(eq.1)

and the leader reward will be:

$${R}_{n} = \frac{α \times {S}_{n}}{{Σ}_{1}^{n - 1} {S}_{i} + α \times {S}_{n}} \times ( {R}_{b} + {Fee}_{tx} )$$

(eq.2)

The mining reward will be dispatched to each node's account at boundary block x*N+N−1. The node might contribute to computing too, and it can get its computing reward and reputation credit scores when the training is completed. The reputation score will impact the chance of joining the next validator group.

Reputation Score of Node

In the platform, besides MPC node, there are two other roles involved: Query Customer (customer user who requests the training service), backend service (i.e., the coordinator of computing tasks). Backend Service Management System has a component called Reputation Builder to provide reputation scores for the nodes to prevent malicious information. For each query that executes on one node, the management system will evaluate the difference between nodes' actual resource usage, query running stats (such as query running time and query throughput) and the resource profiles they have claimed. On the other hand, QC can also leave the feedback of the running status based on their expectations. The reputation score is calculated by the reputation function below:

$${Rep}_{next} = {Rep}_{cur} + γ Q ( α {QC\_Feedback}_{t} + {βSS\_Eval}_{t} , {Rep}_{cur} ) \qquad ( eq . 3 )$$

Where Q is the reputation update function. The Management System, QC feedback and existing reputation score all contribute to the updated score. The reputation score is shown in public for QC's future reference. Also, the incorrect resource profile detected by the Management System will be deprioritized when dispatching queries.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

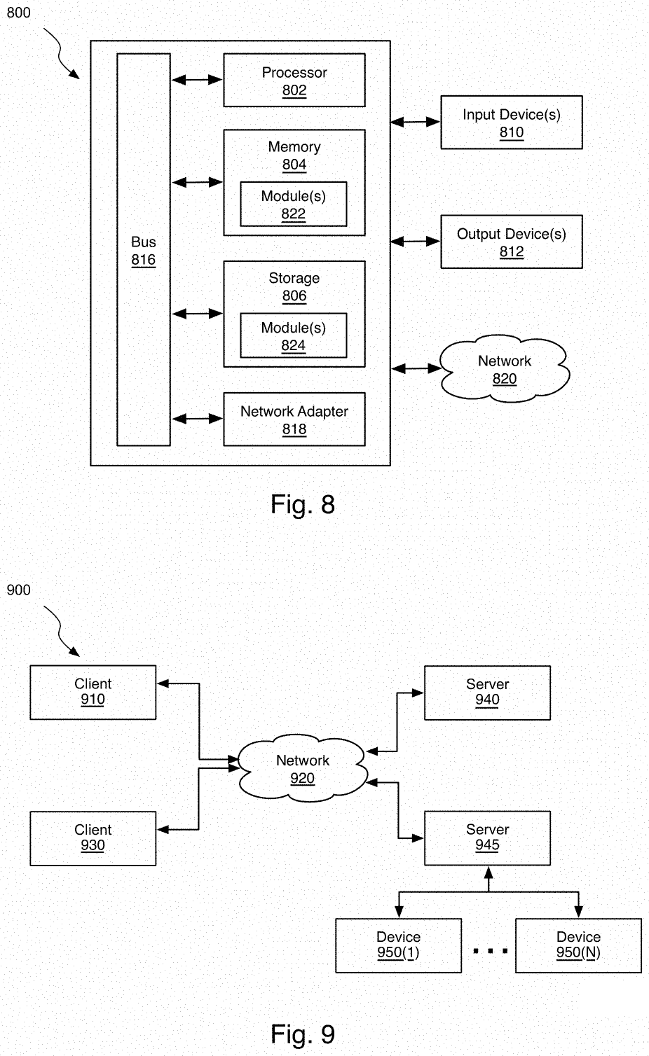

For example, as shown in FIG. 8, the computing system 800 may include one or more computer processor(s) 802, associated memory 804 (e.g., random access memory (RAM), cache memory, flash memory, etc.), one or more storage device(s) 806 (e.g., a hard disk, an optical drive such as a compact disk (CD) drive or digital versatile disk (DVD) drive, a flash memory stick, etc.), a bus 816, and numerous other elements and functionalities. The computer processor(s) 802 may be an integrated circuit for processing instructions. For example, the computer processor(s) may be one or more cores or micro-cores of a processor.

In one or more embodiments, the computer processor(s) 802 may be an integrated circuit for processing instructions. For example, the computer processor(s) 802 may be one or more cores or micro-cores of a processor. The computer processor(s) 802 can implement/execute software modules stored by computing system 800, such as module(s) 822 stored in memory 804 or module(s) 824 stored in storage 806. For example, one or more of the modules described herein can be stored in memory 804 or storage 806, where they can be accessed and processed by the computer processor 802. In one or more embodiments, the computer processor(s) 802 can be a special-purpose processor where software instructions are incorporated into the actual processor design.

The computing system 800 may also include one or more input device(s) 810, such as a touchscreen, keyboard, mouse, microphone, touchpad, electronic pen, or any other type of input device. Further, the computing system 800 may include one or more output device(s) 812, such as a screen (e.g., a liquid crystal display (LCD), a plasma display, touchscreen, or other display device), a printer, external storage, or any other output device. The computing system 800 may be connected to a network 820 (e.g., a local area network (LAN), a wide area network (WAN) such as the Internet, mobile network, or any other type of network) via a network interface connection 818. The input and output device(s) may be locally or remotely connected (e.g., via the network 820) to the computer processor(s) 802, memory 804, and storage device(s) 806.

One or more elements of the aforementioned computing system 800 may be located at a remote location and connected to the other elements over a network 820. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

FIG. 9 is a block diagram of an example of a network architecture 900 in which client systems 910 and 930, and servers 940 and 945, may be coupled to a network 920. Network 920 may be the same as or similar to network 820. Client systems 910 and 930 generally represent any type or form of computing device or system, such as client devices (e.g., portable computers, smart phones, tablets, smart TVs, etc.).

Similarly, servers 940 and 945 generally represent computing devices or systems, such as application servers or database servers, configured to provide various database services and/or run certain software applications. Network 920 generally represents any telecommunication or computer network including, for example, an intranet, a wide area network (WAN), a local area network (LAN), a personal area network (PAN), or the Internet.

With reference to computing system 800 of FIG. 8, a communication interface, such as network adapter 818, may be used to provide connectivity between each client system 910 and 930, and network 920. Client systems 910 and 930 may be able to access information on server 940 or 945 using, for example, a Web browser, thin client application, or other client software. Such software may allow client systems 910 and 930 to access data hosted by server 940, server 945, or storage devices 950(1)-(N). Although FIG. 9 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 940, server 945, storage devices 950(1)-(N), or any combination thereof. All or a portion of one or more of the example embodiments disclosed herein may also be encoded as a computer program, stored in server 940, run by server 945, and distributed to client systems 910 and 930 over network 920.

Although components of one or more systems disclosed herein may be depicted as being directly communicatively coupled to one another, this is not necessarily the case. For example, one or more of the components may be communicatively coupled via a distributed computing system, a cloud computing system, or a networked computer system communicating via the Internet.

And although only one computer system may be depicted herein, it should be appreciated that this one computer system may represent many computer systems, arranged in a central or distributed fashion. For example, such computer systems may be organized as a central cloud and/or may be distributed geographically or logically to edges of a system such as a content/data delivery network or other arrangement. It is understood that virtually any number of intermediary networking devices, such as switches, routers, servers, etc., may be used to facilitate communication.

While the invention has been described with respect to a limited number of embodiments, those skilled in the art, having benefit of this disclosure, will appreciate that other embodiments may be devised that do not depart from the scope of the invention as disclosed herein.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

What is claimed is:

1. A system for federated learning, comprising:
a computer processor;
a backend service configured to:
receive a query from a federated learning query customer;
receive a request for details of the query from a plurality of data owners;
provide details of the query to the plurality of data owners;
receive responses to the query from the plurality of data owners, each response comprising encrypted data; and
trigger execution of a federated learning task using the encrypted data; and
a blockchain driver and monitor executing on the computer processor and configured to enable the computer processor to:
record an indication of the query on a distributed cryptographic blockchain, wherein the plurality of data owners are notified of the query by directly or indirectly observing the distributed cryptographic blockchain; and
record the federated learning task on the distributed cryptographic blockchain, wherein one or more computation nodes are notified of the federated learning task by directly or indirectly observing the distributed cryptographic blockchain.

2. The system of claim 1, wherein the one or more computation nodes is a centralized model training engine and wherein the system further comprises the centralized model training engine.

3. The system of claim 1, wherein the one or more computation nodes is a plurality of multi-party computation nodes, and wherein the system further comprises the plurality of multi-party computation nodes.

4. The system of claim 1, further comprising:
a multi-party computation node configured to:
obtain the encrypted data from the plurality of data owners; and
generate results representing an output of training a global artificial intelligence model using the encrypted data.

5. The system of claim 1, further comprising:
a privacy preservation engine configured to execute a privacy preservation algorithm to enable the encrypted data from the plurality of data owners to be utilized for model training without revealing private information.

6. The system of claim 5, wherein the privacy preservation algorithm is at least one selected from a group consisting of: (i) homomorphic encryption, (ii) multi-party computation, and (iii) differential privacy.

7. The system of claim 1, further comprising:
a data preprocessor configured to:
preprocess source data of the plurality of data owners in order to utilize a standard schema.

8. The system of claim 1, further comprising:
a data standardization module configured to:
identify a custom configuration for each of the plurality of data owners, wherein the custom configuration maps the data owner's content to a network standard schema; and
transform the encrypted data from the plurality of data owners to the network standard.

9. The system of claim 1, wherein the encrypted data is based on a multi-party computation (MPC) with secret sharing (MPC-SS) scheme for vertical federated logistic regression machine learning training used to preserve privacy among the plurality of data owners.

10. A method for federated learning, comprising:
receiving a query from a federated learning query customer;
receiving a request for details of the query from a plurality of data owners;
providing details of the query to the plurality of data owners;
receiving, using a computer processor, responses to the query from the plurality of data owners, each response comprising encrypted data;
triggering, using the computer processor, execution of a federated learning task using the encrypted data;
recording an indication of the query on a distributed cryptographic blockchain, wherein the plurality of data owners are notified of the query by directly or indirectly observing the distributed cryptographic blockchain; and
recording the federated learning task on the distributed cryptographic blockchain, wherein one or more computation nodes are notified of the federated learning task by directly or indirectly observing the distributed cryptographic blockchain.

11. The method of claim 10, wherein the one or more computation nodes is a centralized model training engine and wherein the system further comprises the centralized model training engine.

12. The method of claim 10, wherein the one or more computation nodes is a plurality of multi-party computation nodes, and wherein the system further comprises the plurality of multi-party computation nodes.

13. The method of claim 10, further comprising:
obtaining, by a multi-party computation node, the encrypted data from at least one of the plurality of data owners; and
generating, by the multi-party computation node, results representing part of an output of training a global artificial intelligence model using the encrypted data.

14. The method of claim 10, further comprising:
executing a privacy preservation algorithm to enable the encrypted data from the plurality of data owners to be utilized for model training without revealing private information.

15. The method of claim 14, wherein the privacy preservation algorithm is at least one selected from a group consisting of: (i) homomorphic encryption, (ii) multi-party computation, and (iii) differential privacy.

16. The method of claim 10, further comprising:
preprocessing source data of the plurality of data owners in order to utilize a standard schema.

17. The method of claim 10, further comprising:
identifying a custom configuration for each of the plurality of data owners, wherein the custom configuration maps the data owner's content to a network standard schema; and
transforming the encrypted data from the plurality of data owners to the network standard.

18. The method of claim 10, wherein the encrypted data is based on a multi-party computation (MPC) with secret sharing (MPC-SS) scheme for vertical federated logistic regression machine learning training used to preserve privacy among the plurality of data owners.

19. A non-transitory computer-readable storage medium comprising a plurality of instructions for federated learning, the plurality of instructions configured to execute on at least one computer processor to enable the at least one computer processor to:
receive a query from a federated learning query customer;
receive a request for details of the query from a plurality of data owners;
provide details of the query to the plurality of data owners;
receive responses to the query from the plurality of data owners, each response comprising encrypted data;
trigger execution of a federated learning task using the encrypted data;
record an indication of the query on a distributed cryptographic blockchain, wherein the plurality of data owners are notified of the query by directly or indirectly observing the distributed cryptographic blockchain; and
record the federated learning task on the distributed cryptographic blockchain, wherein one or more computation nodes are notified of the federated learning task by directly or indirectly observing the distributed cryptographic blockchain.

20. The non-transitory computer-readable storage medium of claim 19, the plurality of instructions further configured to execute on the at least one computer processor to enable the at least one computer processor to:
identify a custom configuration for each of the plurality of data owners, wherein the custom configuration maps the data owner's content to a network standard schema; and
transform the encrypted data from the plurality of data owners to the network standard.
